(19) United States
(12) Patent Application Publication
(10) Pub. No.: US 2003/0147029 A1
(43) Pub. Date: Aug. 7, 2003

(54) Structure of a reflective optically self-compensated liquid crystal display

(76) Inventor: Hong-Da Liu, Chu-Pei City (TW)

Correspondence Address: SUPREME PATENT SERVICES, POST OFFICE BOX 2339, SARATOGA, CA, 95070, US

(21) Appl. No.: 10/121,078

(22) Filed: Apr. 11, 2002

(30) Foreign Application Priority Data
Feb. 1, 2002 (TW) 091101808

(51) Int. Cl. G02F 1/1335

(52) U.S. Cl. 349/113

(57) ABSTRACT

A structure of a reflective optically self-compensated liquid crystal display comprises a substrate having a transparent common electrode layer, a substrate having a reflective pixel electrode layer, a polarizer, a series of retardation films, and a uniformly distributed layer of liquid crystals disposed between the two electrode layers. The retardation films serve as a phase compensator. A single circular polarization mode in corporation with birefringence property of the liquid crystal layer and angular optimization among the polarizer, the retardation films and the liquid crystals are used to reduce the light leakage at the dark state on the full spectrum of a visible light. An optically self-compensated effect of the liquid crystal display is achieved.

### FIELD OF THE INVENTION

The present invention relates generally to a structure of a reflective liquid crystal display (LCD), and more specifically to a structure of a reflective optically self-compensated liquid crystal display.

### BACKGROUND OF THE INVENTION

Reflective liquid crystal displays have become popular devices for portable information systems because of their advantages in light weight, thin thickness and low power consumption. A reflective liquid crystal display with excellent legibility under both bright and dark scenes has been developed. However, the liquid crystal reliability still requires improvement for the liquid crystal displays that are reflective twisted nematic (RTN). Because commonly used reflective liquid crystal displays are normally white twisted nematic, their applications in portable products, such as mobile phone, personal digital assistant or notebook computer, require low power consumption. Therefore, the driving voltage to the liquid crystal display must be low. In general, reflective liquid crystal display, driving circuit, system power consumption, operating voltage of liquid crystals and the reliability are closely related in design consideration.

The driving voltage for the commonly used reflective liquid crystal displays is between four and five volts. For lower driving voltage such as less than 2.5 or 3.3 volts, the characteristic of the reflective liquid crystal material requires more improvement. The commonly used reflective liquid crystal material has a refractive index Δn between 0.05 and 0.075 and a dielectric constant Δ∈ between 3 and 7. Improving the characteristic of the reflective liquid crystal material includes increasing the dielectric constant Δ∈ up to 7 and 16. However, such increase will cause the liquid crystal material to adsorb impurities easily and result in poor reliability.

The commonly used reflective liquid crystal displays are operated at normally bright mode. They need quarter-wave compensators to compensate for the wavelength dispersion of liquid crystals in order to reach a good dark state. However, most materials of compensators are used for single wavelength only (in general, green light of wavelength 550 nm) and cannot be operated on the full spectrum of a visible light (400 nm to 700 nm). Therefore, the dark state is not dark enough and the contrast of the displays is inadequate.

### SUMMARY OF THE INVENTION

The present invention has been made to overcome the above-mentioned drawbacks of a conventional reflective liquid crystal display. The primary object is to provide a structure of a reflective optically self-compensated liquid crystal display. The optical principle of the invention is attributed to a single circular polarization mode in corporation with birefringence property in a liquid crystal layer and the angular optimization among a polarizer, retardation films and liquid crystal molecules to reduce the light leakage at the dark state on the full spectrum of a visible light.

The structure of the reflective optically self-compensated liquid crystal display of the invention comprises a substrate having a common electrode layer, a substrate having a pixel electrode layer, a polarizer, one or more retardation films and a uniformly distributed layer of liquid crystals. One electrode layer is transparent and the other is a reflective device. The liquid crystal layer is formed between two electrode layers.

The angle between the polarizer and the average pointing director of liquid crystal molecules in the liquid crystal layer is non-zero. The liquid crystal molecules in the liquid crystal layer are horizontally aligned when no driving voltage is applied. The average pointing director of the liquid crystal molecules in the liquid crystal layer is pre-tilted after the driving voltage is applied. Incident lights pass through the polarizer and form linear polarization. Nearly circular polarization is then formed after the lights pass through the retardation films and the liquid crystal layer. Afterwards, incident lights are reflected by the reflective metal and form nearly linear polarization perpendicular to the polarizer after passing through the retardation films and the liquid crystal layer.

Various structures can be used to manufacture the reflective device of the invention. There are three preferred embodiments of the reflective device including (a) a reflective metal and an inner diffusion layer, (b) a flat reflective metal layer, and (c) a scattering layer, a reflective metal layer, an over-coating layer and an indium tin oxide (ITO) pattern. The structure of the reflective metal layer can be reflective, semi-transparent semi-reflective, or a structure with openings. The shape of the opening can be stripe-shaped, rectangular, squared, circular, or combinations of squares and circles.

According to the invention, optical retardation films are used in the design of reflective optically self-compensated liquid crystal displays that have homogeneously aligned liquid crystal cells operated at normally black mode. The reflective optically self-compensated liquid crystal display can be operated at low driving voltages and has a high contrast ratio as well as a wide viewing angle. Furthermore, excellent reliability and more than 95% polarization effect can be achieved by using typical twisted nematic liquid crystals with a refractive index Δn between 0.07 and 0.15 and a dielectric constant Δ∈ between 5 and 16.

The structure of the reflective optically self-compensated liquid crystal display of the invention can be used in a reflective wide viewing angle TFT LCD of normally black mode, a semi-transparent semi-reflective TFT LCD, a reflective LCD of normally black mode, a semi-transparent semi-reflective LCD, and a partially reflective LCD. The response time of the reflective optically self-compensated splay mode is at least 100% faster than the twisted nematic mode, such as conventional RTN, mixed twisted nematic (MTN) or reflective electrical controlled birefrigence (R-ECB) because of the elastic constant effect. In general, the elastic constant in the splay mode is twice as large as in the twisted nematic mode.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a shows a cross-sectional view of the structure within a pixel area of a reflective liquid crystal display at the dark state according to a first embodiment of the invention.

FIG. 1b shows a cross-sectional view of the structure within a pixel area of a reflective liquid crystal display at the dark state according to the first embodiment of the invention.

FIG. 2a shows a cross-sectional view of the second preferred embodiment of a reflective device according to the invention, wherein the reflective device is a flat reflective metal layer.

FIG. 2b shows a cross-sectional view of the third preferred embodiment of a reflective device according to the invention.

FIGS. 3a-3c show three types of structures of a reflective metal layer according to the invention.

FIGS. 4a-4c show three shapes of opening structures of a reflective metal layer within a pixel area according to the invention.

FIG. 5a shows the threshold voltage and the driving voltage calculated according to the characteristics of liquid crystals under the optically self-compensated structure of the invention.

FIG. 5b shows the simulated results of the voltage-dependent luminance curve of the liquid crystal display for an ultra low driving voltage.

FIG. 5c shows the simulated results of the voltage-dependent reflectivity curve of a 2.2″ reflective optically self-compensated TFT LCD panel of the invention for an ultra low driving voltage.

FIG. 6a shows the angular solution set that satisfies inequality (1).

FIG. 6b shows the angular solution set that satisfies inequality (2) and (3).

FIG. 6c show the second preferred angular solution set that satisfies inequality (4).

FIG. 6d shows the angular solution set that satisfies inequality (5) and (6).

FIG. 6e shows the wavelength vs. the percentage of reflectivity of a liquid crystal display of the invention.

FIG. 6f shows the characteristic of the viewing angle of a reflective liquid crystal display of the invention.

FIGS. 7a-7b show the simulation of iso-intensity contours of liquid crystal molecules at the bright state according to the invention.

FIG. 7b shows the simulation of iso-intensity contours of liquid crystal molecules at the dark state according to the invention.

FIG. 7c shows the equal contrast ratio contours of liquid crystal molecules according to the invention.

FIG. 8 shows the reflective intensity spectrum for each sub-pixel at the bright and dark states in the normal direction according to the invention.

FIG. 9 shows the optical performance in the gray levels for a green sub-pixel.

FIG. 10 shows the comparison of the driving voltages and reliabilities among the RTN liquid crystals, TN liquid crystals, and reflective optically self-compensated liquid crystals of the invention.

### DETAILED DESCRIPTION OF THE PREFERRED EMBODIMENTS

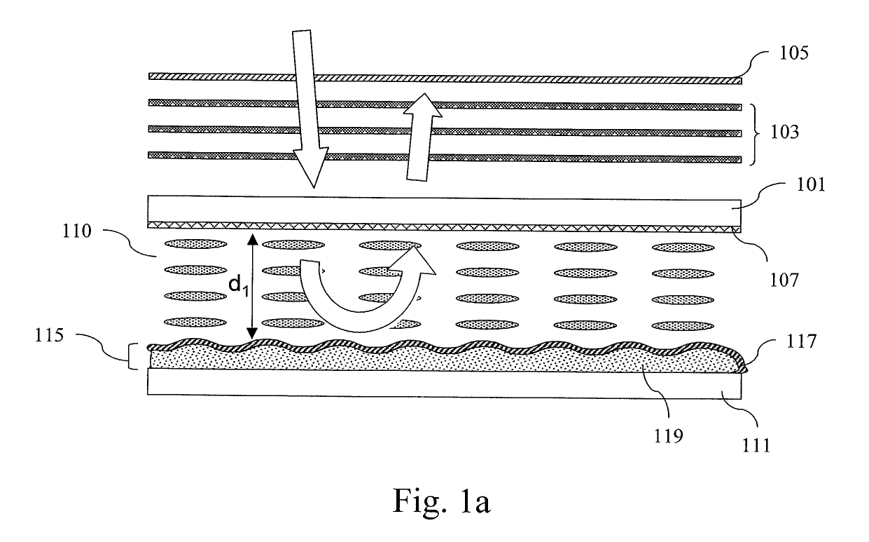

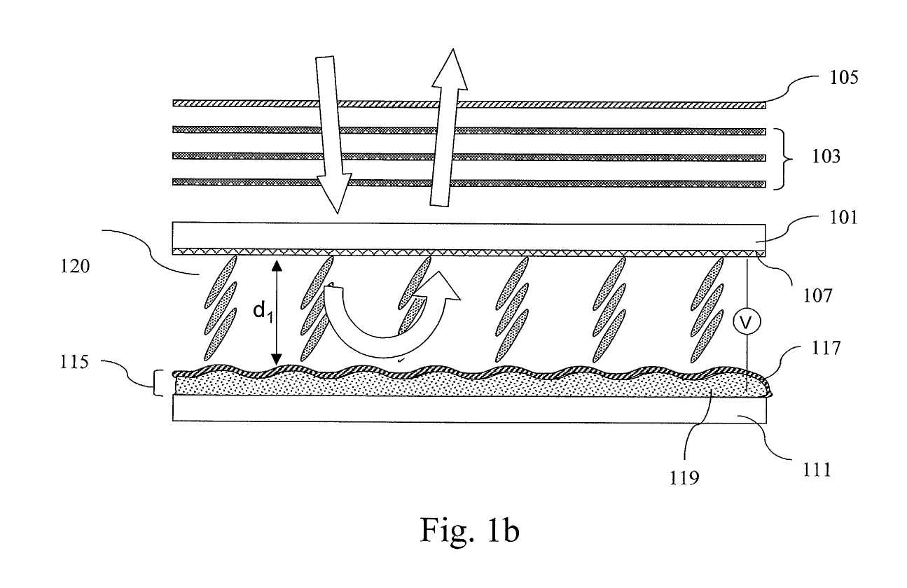

FIGS. 1a and 1b show respectively cross-sectional views of the structure within a pixel area of a reflective liquid crystal display at the dark state and bright state according to the invention. Referring to FIG. 1a, the liquid crystal display comprises an upper substrate 101, a lower substrate 111, a polarizer 105, a series of retardation films 103 and a uniformly distributed layer of liquid crystals 110. A common electrode layer and a pixel electrode layer are formed on substrates 101 and 111 respectively. One electrode layer is transparent and the other is a reflective device. The liquid crystal layer 110 is formed between the two electrode layers.

In the first preferred embodiment, a transparent common electrode layer 107 is formed beneath the upper substrate 101. One or more retardation films 103 are pasted on the upper substrate 101 and the polarizer 105 is pasted on the series of retardation films 103. A pixel electrode layer 115 is formed on the lower substrates 111. A reflective device is fabricated as the pixel electrode layer 115. The reflective device comprises an inner diffusion layer 119 disposed on the lower substrate 111 and a reflective metal layer 117 covering the inner diffusion layer 119.

At the dark state, i.e., no driving voltage is applied to the liquid crystal display, the liquid crystal molecules in the liquid crystal layer 110 are horizontally aligned and the angle between the polarizer and the average pointing director of liquid crystal molecules in the liquid crystal layer is non-zero, as shown in FIG. 1a. The average pointing director of liquid crystal molecules in the liquid crystal layer 110 is horizontal.

At the bright state, when a driving voltage is applied, incident lights pass through the polarizer 105 and form linear polarization. Nearly circular polarization is then formed after the incident lights pass through the retardation films 103 and the liquid crystal layer 110. Afterwards, incident lights are reflected by the reflective metal layer 117 and form nearly linear polarization perpendicular to the polarizer 105 after passing through the retardation films 103 and the liquid crystal layer 110. Referring to FIG. 1b, the average pointing director of liquid crystal molecules in the liquid crystal layer 120 is pre-tilted when the driving voltage is applied.

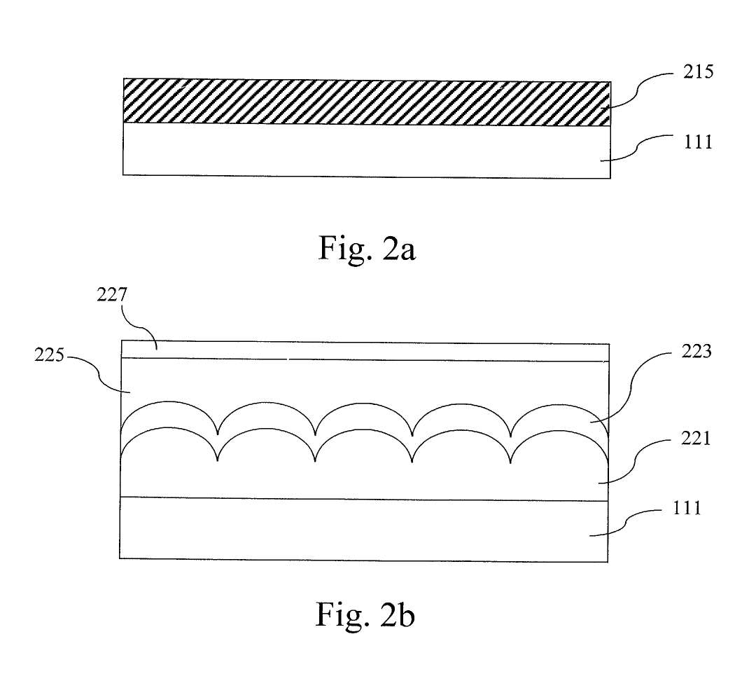

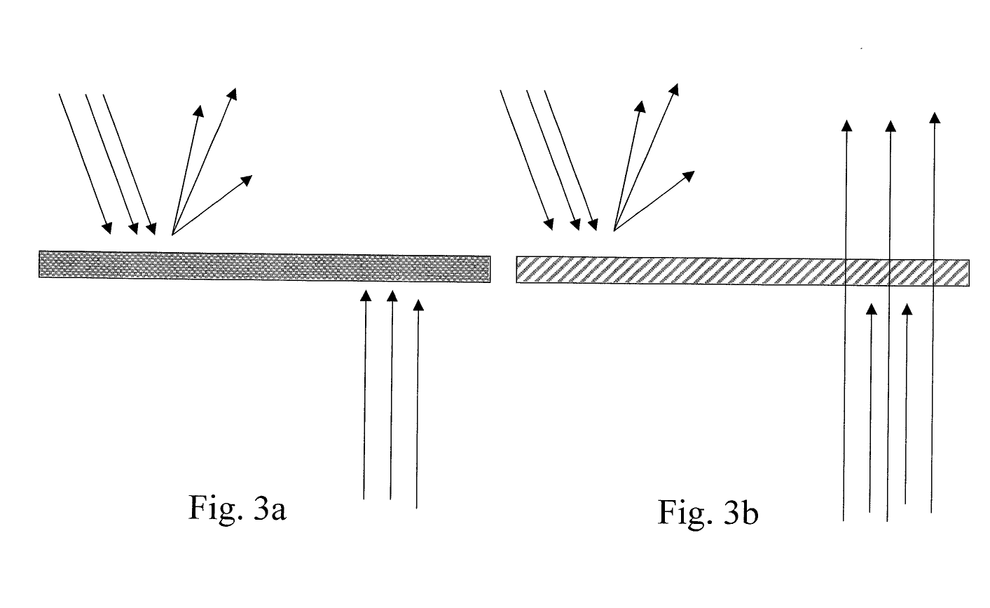

The reflective device may have various structures according to the invention. The first embodiment of the reflective device has been illustrated in FIGS. 1a and 1b. FIG. 2a shows a cross-sectional view of the second preferred embodiment of the reflective device which is a flat reflective metal layer 215. FIG. 2b shows a cross-sectional view of the third preferred embodiment of a reflective device. In the third embodiment, the reflective device comprises a scattering layer 221 on the pixel electrode layer substrate 111, a reflective metal layer 223 on the scattering layer, an over-coating layer 225 on the reflective metal layer 223 and an indium tin oxide (ITO) pattern 227 on the over-coating layer 225.

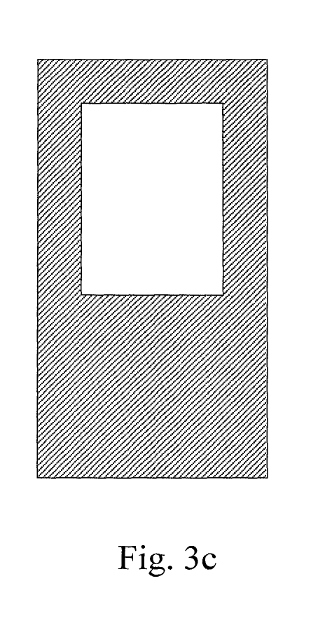

The reflective devices in the three embodiments all include a reflective metal layer. According to the invention, the material for the reflective metal layer can be aluminum (Al), silver (Ag), aluminum alloy, silver alloy, or high reflective multi-layer films. The structure of the reflective metal layer can be reflective, semi-transparent semi-reflective, or a structure with openings. FIGS. 3a-3c show respectively the three types of structures of a reflective metal layer.

The preferred embodiment for the semi-transparent semi-reflective structure of the reflective metal layer shown in FIG. 3b can either be an aluminum alloy with film thickness in a range between 50 Å and 500 Å, or a silver alloy with film thickness in a range between 500 Å and 2000 Å.

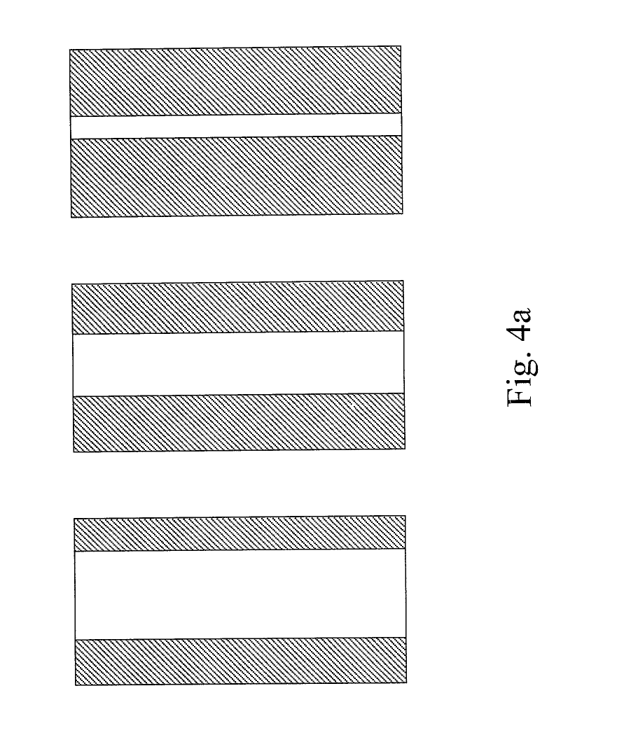

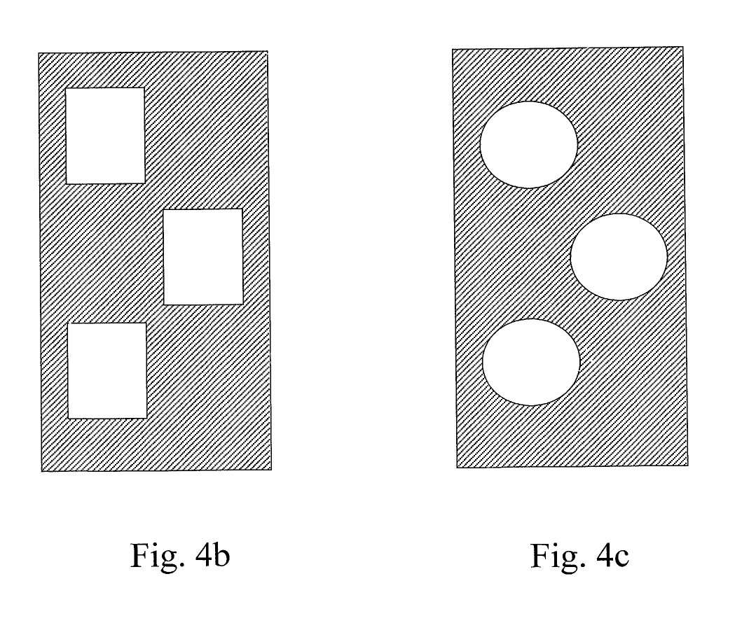

An opening in the reflective device is also called a transparent area. The shape of the opening shown in FIG. 3c of a reflective metal layer within a pixel area is selected from the group of a stripe, a rectangular, a square, circle, or a combination of squares and circles. FIGS. 4a-4c show three shapes of the opening of a reflective metal layer within a pixel area. In the figures, blank areas represent transparent areas and slanted lined areas represent reflective areas. The reflective effect of the stripe-shaped opening shown in FIG. 4a is better when the ratio T: T+R of the transparent area T to the summation of the transparent area T and the reflective area R is between 5% and 30%.

According to the invention, the common electrode layer substrate may comprise a color filter. The pixel electrode layer may be an active matrix device, such as thin film transistor (TFT) or thin film diode (TFD), or a passive matrix device with stripe-shaped electrodes. The material for the transparent electrode layer can be an ITO or an indium zinc oxide (IZO). The material for the scattering layer can be a positive or negative photo-resist or an acrylic resin. The material for the retardation films includes macromolecular polymers. The range of the film thickness for the retardation films is typically between 20 nm and 180 nm. The retardation films can be uni-axial, such as A-plate or C-plate, bi-axial or the combination of A-plate and O-plate.

As mentioned above, the optical principle of the invention is attributed a single circular polarization mode in corporation with birefringence property in the liquid crystal layer and the angular optimization to reduce the light leakage at the dark state on the full spectrum of a visible light. The following describes in detail the circular polarization mode and the angular optimization among the polarizer 105, the retardation films 103 and liquid crystal molecules.

In the reflective area, the reflective mode of the liquid crystal display of the invention uses a single circular polarization mode formed by a series of retardation films, a homogeneous liquid crystal layer and a polarizer. As shown in FIGS. 1a and 1b, the front side of the LCD panel has a series of retardation films 103, which is used as a phase compensator.

In order to compensate for the wavelength dispersion of liquid crystals and retardation films, this invention realizes the good dark state with a wide viewing angle by optimizing the parameters, viewing angle and wavelength dependency. When an electric field is applied, the reflectivity in the reflective optically self-compensated mode is modulated from dark to bright.

In the transparent area, when the voltage is not applied, the combination of the liquid crystal layer and retardation films forms a circular polarization mode. The retardation films behave like a wide-band quarter-wave plate. That means an ideal dark state also appears on the transparent area without an electric field. At the bright state, the phase retardation of the liquid crystal layer is also modulated to get high efficiency light reflectivity as in an ideal twisted nematic liquid crystal display.

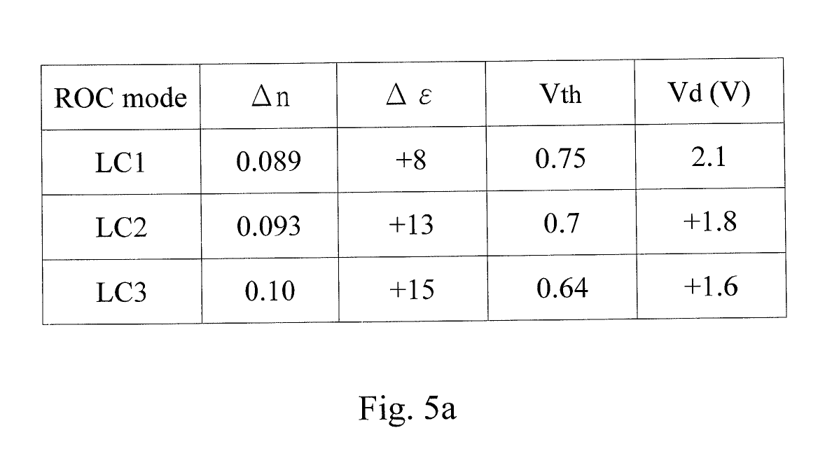

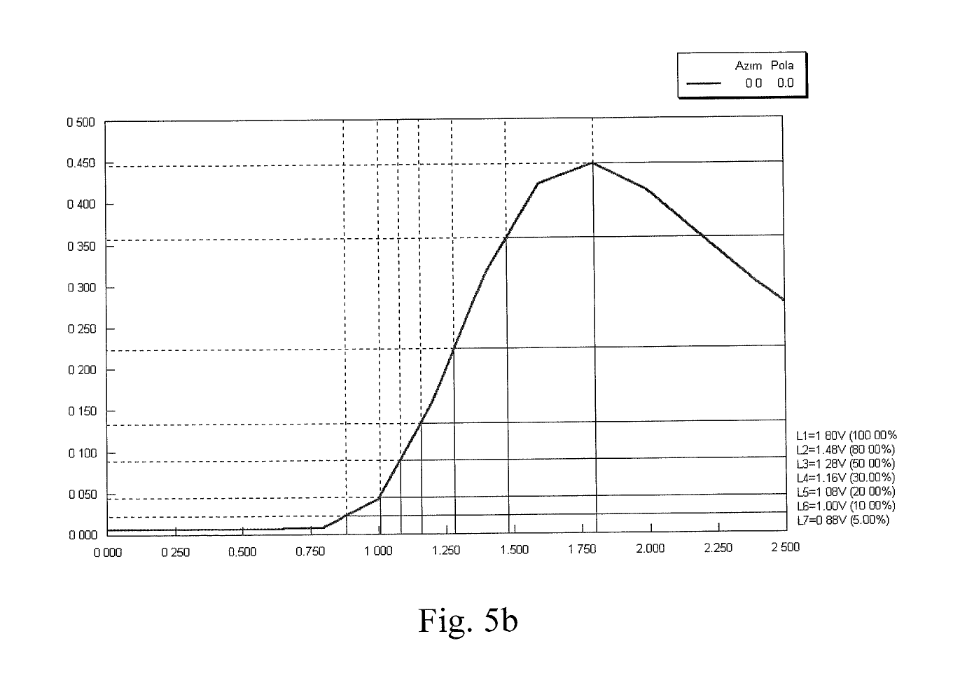

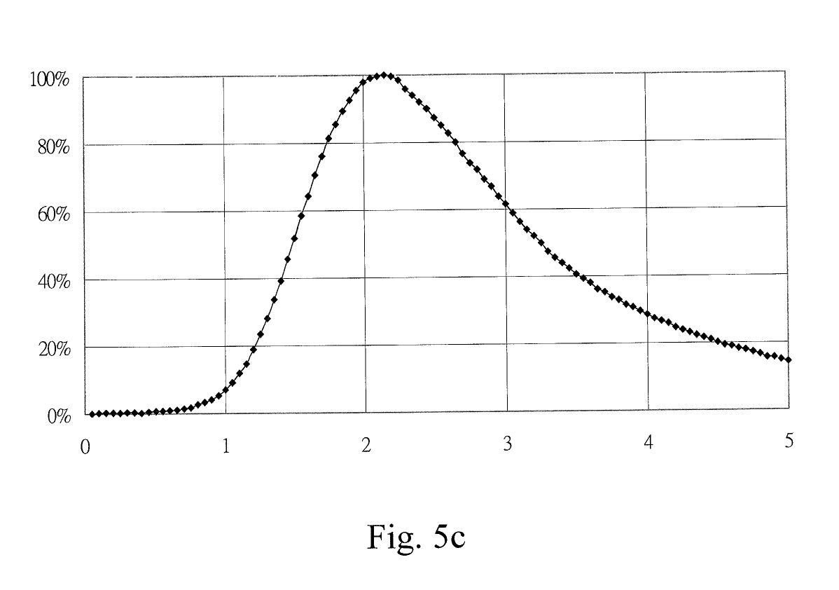

According to the invention, the dynamic phase retardation range of the liquid crystal layer is designed to get an ideal polarization effect with an ultra low driving voltage as in reflective twisted nematic and mixed twisted nematic liquid crystal displays. FIG. 5a illustrates that the liquid crystal layer modulation of the invention can be operated below two volts.

FIG. 5a shows the threshold voltage Vₜₕ and the driving voltage V_{d} calculated according to the characteristics of the liquid crystals under the optically self-compensated structure of the invention. There are three simulated liquid crystals LC1, LC2 and LC3 with characteristics that the refractive indices Δn are respectively 0.089, 0.093 and 0.10, the dielectric constants Δ∈ are respectively 8, 13 and 15, the calculated threshold voltages Vₜₕ are respectively 0.75, 0.7 and 0.64 volts, and the calculated driving voltages V_{d} are respectively 2.1, 1.8 and 1.6 volts.

FIG. 5b shows the simulated results of the voltage-dependent luminance curve in the design for an ultra low driving voltage. The vertical axis in FIG. 5b represents the luminance and the horizontal axis represents the driving voltage. The simulated liquid crystal is LC2. The calculated threshold voltage Vₜₕ is 0.7 volts, which is very low and less than 1 volt. The greatest luminance is about 0.45 at the driving voltage V_{d} around 1.8 volts, which is below one-sixth of the power consumption of a conventional liquid crystal display. Note that one-sixth is about the square of 1.8 divided by the square of 5.

FIG. 5c shows the simulated results of the voltage-dependent reflectivity curve in the design for an ultra low driving voltage. The vertical axis in FIG. 5c represents the reflectivity and the horizontal axis represents the driving voltage of a 2.2″ reflective optically self-compensated TFT LCD panel. The calculated threshold voltage Vₜₕ is 0.7 volts. When the reflectivity reaches 100%, the driving voltage V_{d} is about 2.1 volts, which is below one-fifth of the power consumption of a conventional liquid crystal display. Note that one-fifth is about the square of 2.1 divided by the square of 5.

Using the above-mentioned nearly circular polarization mode in corporation with birefringence property in the liquid crystal layer and the angular optimization among the polarizer, the retardation films and liquid crystal molecules, this invention could reduce the light leakage at the dark state on the full spectrum of a visible light.

This invention gets two angular solution sets from experimental results for reducing the light leakage at the dark state on the full spectrum of a visible light. Let d be the liquid crystal cell gap, R be the phase difference of retardation films, θ₁ be the angle between the polarizer and retardation films, θ₂ be the angle between the polarizer and the liquid crystal layer, Δn be the refractive index.

The first preferred angular solution set of the invention is described in the following. When the characteristic of liquid crystals and the phase difference of the retardation films have the following inequality equation (1),

0.85≦(Δn·d)/2R≦1.15 (1)

the angular solution set of θ₁ and θ₂ satisfies the following inequality equations (2) and (3).

θ₁−30°≦3θ₂≦θ₁+30° (2)

35°≦θ₂≦55° or 35°≦θ₂−90°≦55° (3)

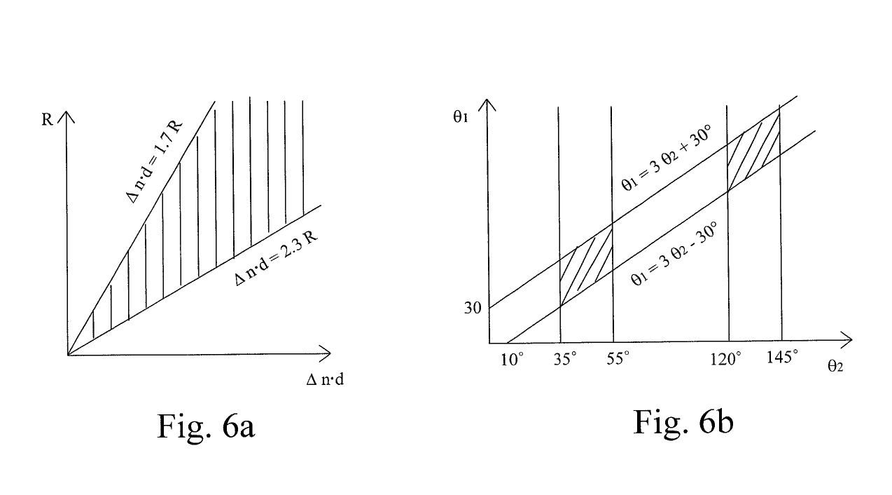

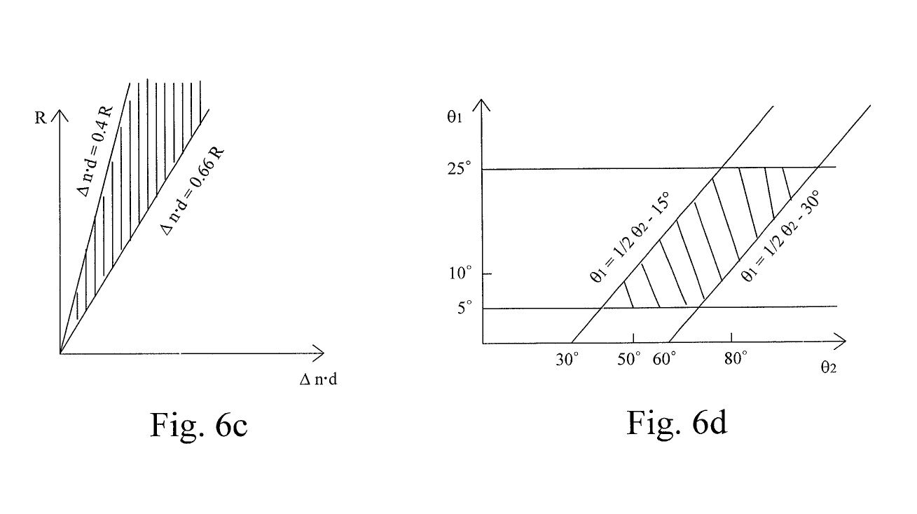

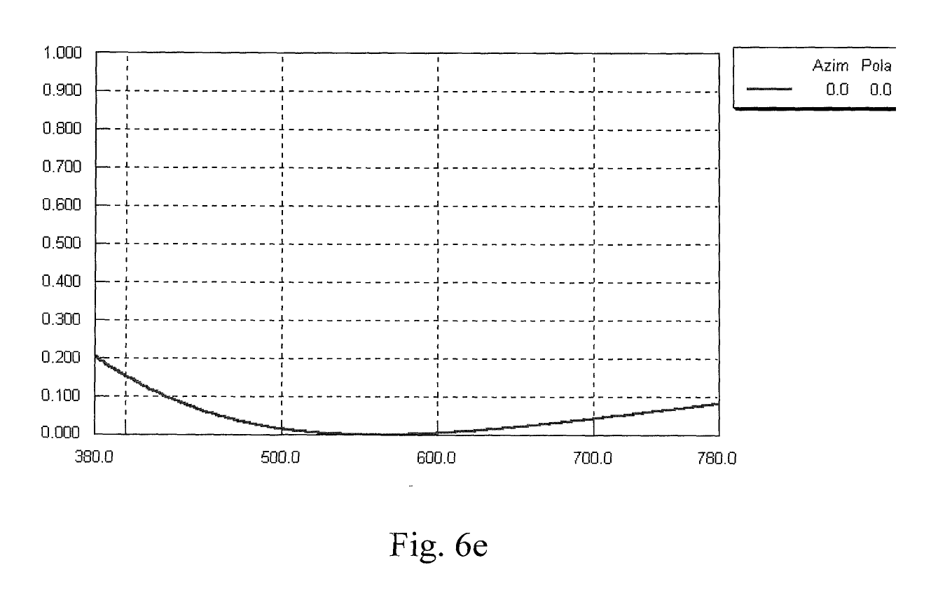

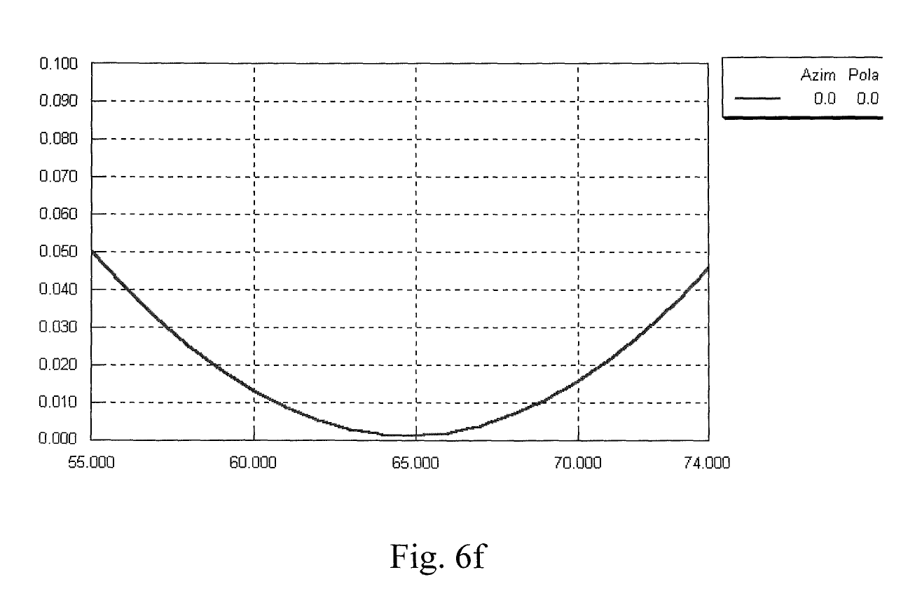

The slanted lined area in FIG. 6a is the solution set that satisfies inequality equation (1) where the horizontal axis represents the characteristic of liquid crystals, that is Δn multiplied by d, and the vertical axis represents the phase difference R of the retardation films. The slanted lined area in FIG. 6b is the solution set that satisfies inequality equations (2) and (3). The horizontal axis is θ₂ and the vertical axis is θ₁ in the figure. Liquid crystals with the characteristic that the refractive index Δn is between 0.07 and 0.15 and the dielectric constant Δ∈ is greater than or equal to 5 will have lower threshold voltage and driving voltage. That means lower power consumption. Therefore, the first preferred angular solution set of the invention could reduce the light leakage at the dark state on the full spectrum of a visible light.

The second preferred angular solution set of the invention is as follows. When the characteristic of liquid crystals and the phase difference of retardation films have the following inequality equation (4),

0.2≦(Δn·d)/2R≦0.33 (4)

the angular solution set of θ₁ and θ₂ satisfies the following inequality equations (5) and (6).

2θ₁+30°≦θ₂≦2θ₁+60° (5)

5°≦θ₁≦25° (6)

The slanted lined area in FIG. 6c is the solution set that satisfies inequality equation (4) where the horizontal axis represents the characteristic of liquid crystals, that is Δn multiplied by d, and the vertical axis represents the phase difference R of the retardation films. The slanted lined area in FIG. 6d is the solution set that satisfies inequality equations (5) and (6) where the horizontal and vertical axes are θ₂ and θ₁ respectively. Liquid crystals with characteristic that the refractive index Δn is between 0.045 and 0.095 and the dielectric constant Δ∈ is greater than or equal to 2.5 will have lower threshold voltage and driving voltage. That means lower power consumption. Therefore, the second preferred angular solution set of the invention could reduce the light leakage at the dark state on the full spectrum of a visible light.

Although the first and second preferred angular solution sets use the characteristic of existing material for retardation films, the design of the structure in the optical system of the invention achieves some special properties that are normally not obtained from the existing material. The invention does not require expensive multi-layer coating or sputtering process either. Its advantages include low manufacturing cost and easy mass production. In addition, the design is helpful to the optical characteristic of reflective liquid crystal displays and can reduce the light leakage at the dark state as well as increase substantially the contrast ratio as shown in FIG. 6e.

With reference to FIG. 6e, the horizontal axis represents the wavelength and the vertical axis represents the percentage of reflectivity of liquid crystal displays of the invention. In the full spectrum of a visible light, i.e., wavelength between 400 nm and 700 nm, the reflectivity is below 0.001. That means the contrast ratio is as high as 1000:1, which is much higher than that designed for green light in a conventional reflective liquid crystal display.

FIG. 6f shows the characteristic of the viewing angle of a reflective liquid crystal display of the invention. The horizontal axis in FIG. 6f represents the angle between the polarizer and the retardation films, and the vertical axis represents the percentage of reflectivity of reflective liquid crystal displays. As can be seen, the invention still has a good dark state operating at a wide viewing angle. It improves the characteristic of the viewing angle of a conventional reflective liquid crystal display. The reflectivity at the dark state is below 0.01 when the viewing angle is about 80° at up, down, left and right directions. That means the contrast ratio is as high as 50:1 in these directions.

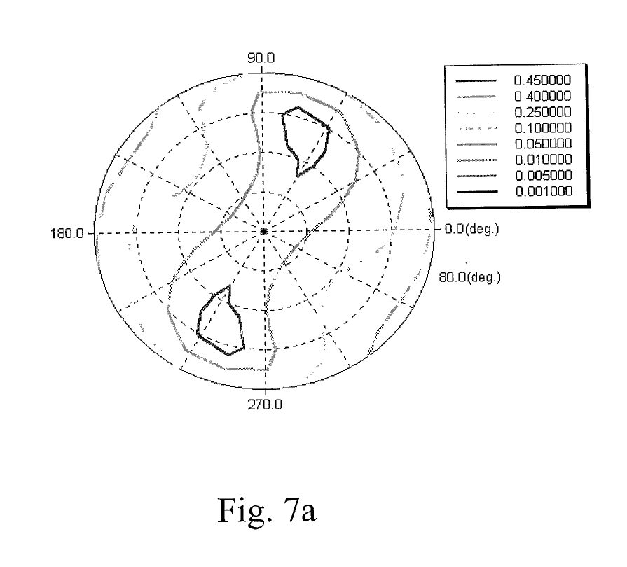

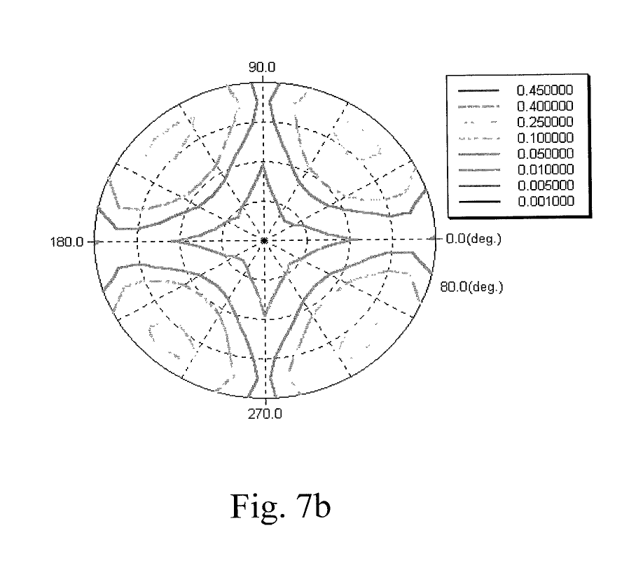

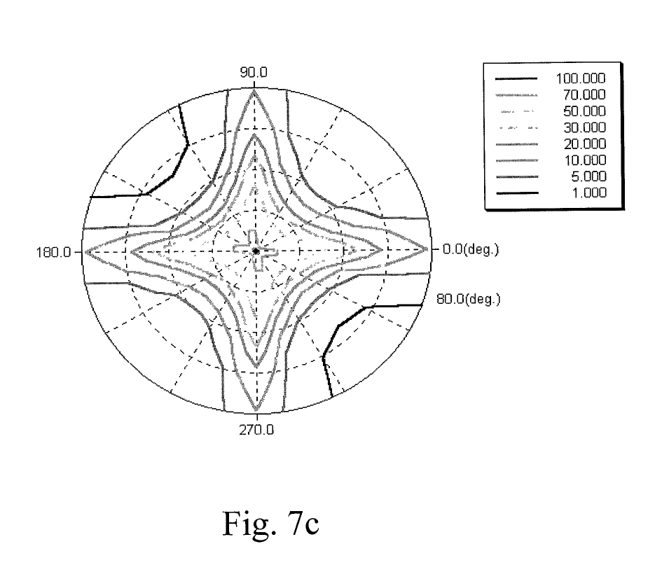

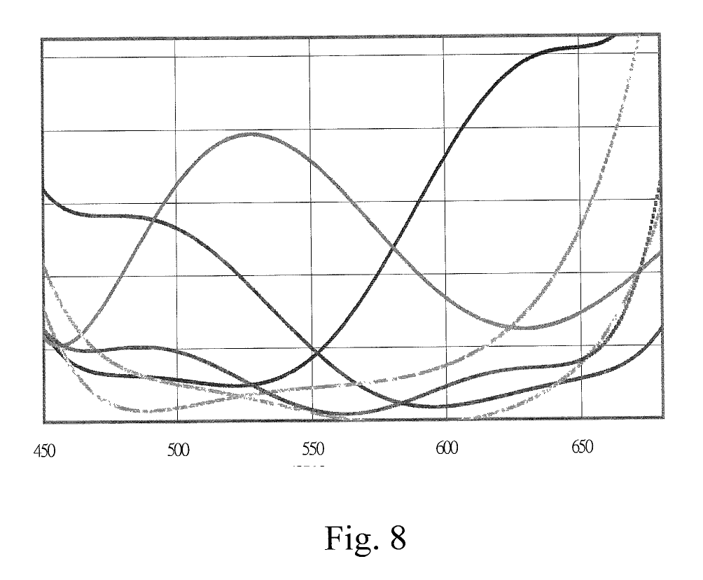

As discussed above, this invention uses a series of retardation films and proper angular optimization to design the visible light full spectrum quarter-wave compensator in order to reduce the light leakage at the dark state on full spectrum of a visible light. It has substantially high contrast ratio and wide viewing angles for up, down, left and right directions. Accordingly, the reflective liquid crystal display of the invention has an optically self-compensated property. FIGS. 7a-7b show the simulation of iso-intensity contours of liquid crystal molecules according to the invention. FIG. 7a shows the iso-intensity contours of liquid crystal molecules at the bright state when the voltage of 1.8 volts is applied. FIG. 7b shows the iso-intensity contours of liquid crystal molecules at the dark state when no voltage is applied. FIG. 7c shows the equal contrast ratio contours of liquid crystal molecules. Excellent results at the dark state and at the bright state have been shown in FIGS. 7a and 7b, and a high contrast ratio is also shown in FIG. 7c. The viewing angle is very wide for up, down, left and right directions.

The liquid crystal directors at the dark state are homogeneously aligned to the substrates as shown in FIG. 1a. The reflective optically self-compensated LCD panels of the invention are operated at the normally black mode. The dark state is perfectly dark due to the wide-band wavelength dispersion and the characteristics of the wide viewing angle. The reflectivity increases when the applied voltages are larger than the threshold voltage of 0.7 volts because the liquid crystal molecules splay to modulate the phase retardation. And it can reach to over 80% compared with standard white when the voltage of 2 volts is applied. The response time of the reflective optically self-compensated splay mode of liquid crystal molecules is expected to be twice faster than that of the twisted nematic mode, such as conventional RTN, MTN or reflective electrical controlled birefringence (R-ECB) mode because of the elastic constant in the splay mode is twice as large as in the twisted nematic mode.

FIG. 8 shows the reflective intensity spectrum for each sub-pixel of reflective optically self-compensated liquid crystal displays of the invention at the bright and dark states in the normal direction, where the vertical axis represents the reflectivity intensity and the horizontal axis represents the wavelength.

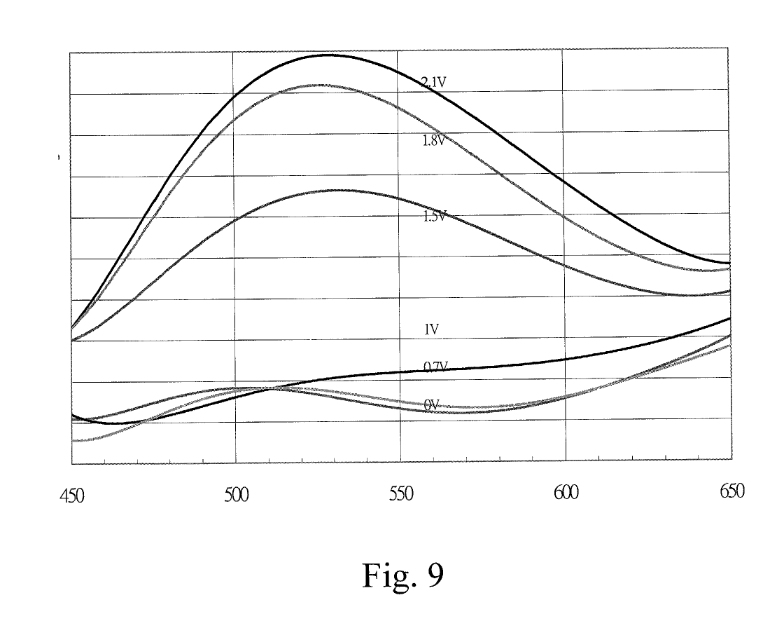

FIG. 9 shows the optical performance in the gray levels for a green sub-pixel, where the vertical axis represents the reflectivity intensity and the horizontal axis represents the wavelength. The driving voltages are respectively 0, 0.7, 1.0, 1.5, 1.8, and 2.1 volts in sequence.

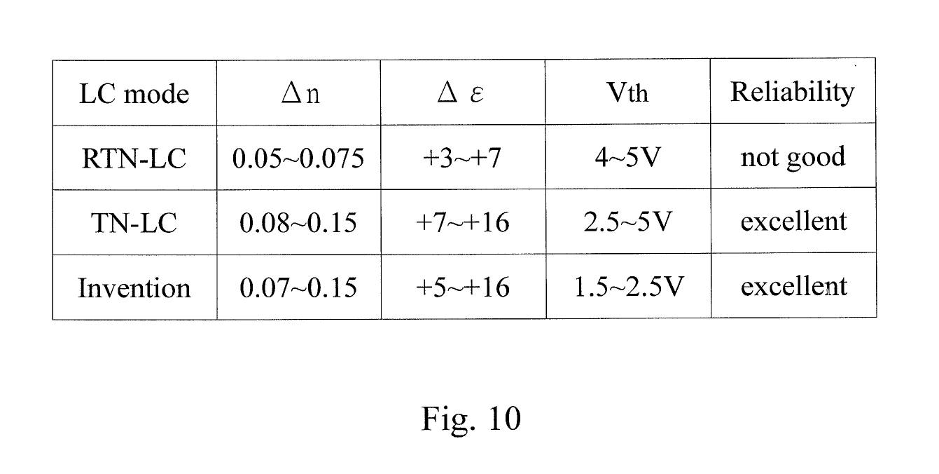

Another advantage of the invention is the reliability of the liquid crystal material. By means of the structure of the reflective optically self-compensated cell, this invention can use the same liquid crystal material as typical TN but still achieve a pretty high reliability. FIG. 10 shows the comparison of the threshold voltages and reliabilities among the RTN liquid crystals, TN liquid crystals, and reflective optically self-compensated liquid crystals of the invention. As shown in FIG. 10, this invention uses typical TN liquid crystals of Δn between 0.07 and 0.15 and Δ∈ between 5 and 16 and achieves excellent reliability as well as low threshold voltages of 1.5 to 2.5 volts.

The structure of a reflective optically self-compensated liquid crystal display of the invention can be used in a wide viewing angle normally-black mode reflective TFT LCD, a semi-transparent semi-reflective TFT LCD, a normally-black mode reflective, semi-transparent semi-reflective LCD, and a partially reflective LCD.

In summary, the reflective optically self-compensated liquid crystal display of the invention can be operated at low driving voltages and has a high contrast ratio as well as a wide viewing angle. It can use typical twisted nematic liquid crystals of Δn between 0.07 and 0.15 and Δ∈ between 5 and 16 and still has excellent reliability.

Although this invention has been described with a certain degree of particularity, it is to be understood that the present disclosure has been made by way of preferred embodiments only and that numerous changes in the detailed construction and combination as well as arrangement of parts may be restored to without departing from the spirit and scope of the invention as hereinafter set forth.

What is claimed is:

1. A structure of a reflective optically self-compensated liquid crystal display, comprising:
an upper substrate having a common electrode layer formed underneath, said common electrode layer being transparent;
a lower substrate having a pixel electrode layer formed thereon, said pixel electrode layer comprising a reflective device;
at lease one retardation film formed above said upper substrate;
a polarizer formed on said at least one retardation film; and
a uniformly distributed layer of liquid crystals disposed between said common and pixel electrode layers, said liquid crystals having liquid crystal molecules horizontally aligned when no driving voltage is applied and said liquid crystal molecules having an averaging pointing director which forms a non-zero angle with said polarizer; wherein incident lights pass through said polarizer, form linear polarization, and then form nearly circular polarization after passing through said at least one retardation film and said layer of liquid crystals when a driving voltage is applied, and the incident lights are reflected by said reflective device and form nearly linear polarization perpendicular to said polarizer after passing through said at least one retardation film and said layer of liquid crystals.

2. The structure of a reflective optically self-compensated liquid crystal display as claimed in claim 1, wherein said upper substrate has a color filter thereon.

3. The structure of a reflective optically self-compensated liquid crystal display as claimed in claim 1, wherein said pixel electrode layer is an active matrix device with stripe-shaped electrodes.

4. The structure of a reflective optically self-compensated liquid crystal display as claimed in claim 3, wherein said active matrix device is a thin film transistor or a thin film diode.

5. The structure of a reflective optically self-compensated liquid crystal display as claimed in claim 1, wherein said pixel electrode layer is a passive matrix device with stripe-shaped electrodes.

6. The structure of a reflective optically self-compensated liquid crystal display as claimed in claim 1, wherein said common electrode layer is an electrode layer comprising an indium tin oxide or an indium zinc oxide.

7. The structure of a reflective optically self-compensated liquid crystal display as claimed in claim 1, wherein said at least one retardation film is used as a phase compensator.

8. The structure of a reflective optically self-compensated liquid crystal display as claimed in claim 1, wherein said at least one retardation film comprises macro-molecular polymers.

9. The structure of a reflective optically self-compensated liquid crystal display as claimed in claim 1, wherein said at least one retardation film has a thickness between 20 nm and 180 nm.

10. The structure of a reflective optically self-compensated liquid crystal display as claimed in claim 1, wherein said at least one retardation film comprises a material chosen from the group of a uni-axial extension film, a bi-axial extension film and a combination of A-plate, O-plate and C-plate.

11. The structure of a reflective optically self-compensated liquid crystal display as claimed in claim 1, said liquid crystal display is a wide viewing angle normally-black mode reflective thin film transistor liquid crystal display, a semi-transparent semi-reflective thin film transistor liquid crystal display, a normally-black mode reflective and semi-transparent semi-reflective liquid crystal display, or a partially reflective liquid crystal display.

12. The structure of a reflective optically self-compensated liquid crystal display as claimed in claim 1, wherein said reflective device comprises a reflective metal layer having a material chosen from the group of aluminum, silver, an aluminum alloy, a silver alloy, and high reflective multi-layer films.

13. The structure of a reflective optically self-compensated liquid crystal display as claimed in claim 1, wherein said reflective device has a reflective structure.

14. The structure of a reflective optically self-compensated liquid crystal display as claimed in claim 1, wherein said reflective device has a semi-transparent semi-reflective structure.

15. The structure of a reflective optically self-compensated liquid crystal display as claimed in claim 1, wherein said reflective device has a structure with at least an open area within a pixel area.

16. The structure of a reflective optically self-compensated liquid crystal display as claimed in claim 15, wherein said at least an open area within a pixel area has a shape selected from the group of a stripe, a rectangular, a square, a circle, or a combination of at least a square and a circle.

17. The structure of a reflective optically self-compensated liquid crystal display as claimed in claim 1, wherein said reflective device has a structure with transparent and reflective areas within a pixel area, and the ratio of said transparent area to the summation of said transparent and reflective areas is between 5% and 30%.

18. The structure of a reflective optically self-compensated liquid crystal display as claimed in claim 1, wherein said reflective device has a reflective metal layer formed by an aluminum alloy with a film thickness between 50 Å and 500 Å.

19. The structure of a reflective optically self-compensated liquid crystal display as claimed in claim 1, wherein said reflective device has a reflective metal layer formed by a silver alloy with a film thickness between 500 Å and 2000 Å.

20. The structure of a reflective optically self-compensated liquid crystal display as claimed in claim 1, wherein said reflective device is a flat reflective metal layer.

21. The structure of a reflective optically self-compensated liquid crystal display as claimed in claim 1, wherein said reflective device comprises an inner diffusion layer formed on said lower substrate and a reflective metal layer covering said inner diffusion layer.

22. The structure of a reflective optically self-compensated liquid crystal display as claimed in claim 1, said reflective device further comprising:
a scattering layer formed on said lower substrate;
a reflective metal layer formed on said scattering layer;
an over-coating layer formed on said reflective metal layer; and
an indium tin oxide pattern formed on said over-coating layer.

23. The structure of a reflective optically self-compensated liquid crystal display as claimed in claim 22, wherein said scattering layer comprises a material chosen from the group of a positive photo-resist, a negative photo-resist and an acrylic resin.

24. The structure of a reflective optically self-compensated liquid crystal display as claimed in claim 1, wherein a single circular polarization mode in corporation with birefringence property of said layer of liquid crystals and angular optimization among said polarizer, said at least one retardation film and said layer of liquid crystals are used to reduce light leakage at a dark state on the full spectrum of a visible light.

25. The structure of a reflective optically self-compensated liquid crystal display as claimed in claim 24, wherein said angular optimization among said polarizer, said at least one retardation film and said layer of liquid crystals has a solution set of θ₁ and θ₂ that satisfies inequality equations:
θ₁−30°≦3θ₂≦θ₁+30° and
35°≦θ₂≦55° or 35°≦θ₂−90°≦55°
when an inequality equation 0.85≦(Δn·d )/2R≦1.15 is satisfied, wherein d is gap height of said layer of liquid crystals, R is phase difference of said at least one retardation film, θ₁ is an angle between said polarizer and said at least one retardation film, θ₂ is an angle between said polarizer and said layer of liquid crystals, Δn is a refractive index of said layer of liquid crystals.

26. The structure of a reflective optically self-compensated liquid crystal display as claimed in claim 25, wherein said layer of liquid crystals has a refractive index Δn between 0.07 and 0.15 and a dielectric constant Δ∈ greater than or equal to 5.

27. The structure of a reflective optically self-compensated liquid crystal display as claimed in claim 24, wherein said angular optimization among said polarizer, said at least one retardation film and said layer of liquid crystals has a solution set of θ₁ and θ₂ that satisfies inequality equations:
2θ₁+30°≦θ₂≦2θ₁+60° and
5°≦θ₁≦25°
when an inequality equation 0.2≦(Δn·d)/2R≦0.33 is satisfied, wherein d is gap height of said layer of liquid crystals, R is phase difference of said at least one retardation film, θ₁ is an angle between said polarizer and said at least one retardation film, θ₂ is an angle between said polarizer and said layer of liquid crystals, Δn is a refractive index of said layer of liquid crystals.

28. The structure of a reflective optically self-compensated liquid crystal display as claimed in claim 27, wherein said layer of liquid crystals has a refractive index Δn between 0.045 and 0.095 and a dielectric constant Δ∈ greater than or equal to 2.5.
